(19) United States
(12) Patent Application Publication
(10) Pub. No.: US 2014/0027143 A1
(43) Pub. Date: Jan. 30, 2014

(54) Electrical Box Insert Device

(71) Applicants: Michael Hunter, Bolton (CA); Mathew Hunter, Bolton (CA)

(72) Inventors: Michael Hunter, Bolton (CA); Mathew Hunter, Bolton (CA)

(21) Appl. No.: 13/948,464

(22) Filed: Jul. 23, 2013

Related U.S. Application Data
(60) Provisional application No. 61/674,989, filed on Jul. 24, 2012.

(51) Int. Cl. H02G 3/18

(52) U.S. Cl. CPC H02G 3/18
USPC 174/53

(57) ABSTRACT

An electrical box insert device is disclosed that provides users with an easy way to terminate power to pot lights and electrical devices. The electrical box insert device comprises a housing sized to be inserted into an existing electrical box. A sheathed electrical cable is inserted through an opening of the housing and secured to a conductive bus bar continuatively connecting cables and/or terminating power to an electrical box. Typically, a user manually strips the outer sheath of the cables and the conductor sheath, exposing the conductors. The exposed conductors can then be secured to the conductive bus bar continuatively connecting cables. Furthermore, an electrical outlet can be secured via a sheathed electrical cable to the conductive bus bar continuatively connecting cables.

### CROSS-REFERENCE

This application claims priority from Provisional Patent Application Ser. No. 61/674,989 filed Jul. 24, 2012.

### BACKGROUND

The traditional method currently in use by electricians for installing electrical boxes can be both laborious and time consuming. Therefore, electrical work can be extremely expensive for a homeowner. Furthermore, the process requires special blades and wire strippers and the repetitive nature of the various steps involved could lead to an injury for the electrician (e.g., carpal tunnel, cuts, etc.). Also, the current way that electrical boxes are installed leaves the wires vulnerable to being snipped or damaged by workers installing drywall or performing other work in the house or building. An effective solution is needed.

The present invention provides users with an easy way to install/remove electrical outlets/switches in a electrical box. The electrical box insert device allows electricians to work much more efficiently when installing and roughing in an electrical box or pot light. The disclosed device combines several steps to save an electrician time and energy. Further, the electrical box insert device does not leave wires vulnerable to being snipped or damaged by workers performing work in the house or building. Anyone who regularly installs and/or roughs in an electrical box or pot light may appreciate the convenience afforded by this device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an electrical box insert device that provides users with an easy way to terminate power to pot lights and electrical devices. The electrical box insert device comprises a housing, wherein at least one conductive bus bar is secured in the housing, and at least one opening is positioned on either end of the housing. The housing is sized to be inserted into an existing electrical box, or can also be sized to replace a back plate of an existing electrical box. The at least one conductive bus bar is powered by electrical lines that run from the fuse box to the housing and is used to place the electrical box insert device in electrical communication with the existing electrical box. Specifically, at least one sheathed electrical cable is inserted through the at least one opening and secured to the at least one conductive bus bar continuatively connecting cables and/or terminating power to an electrical box.

In a preferred embodiment, the opening is sized to accommodate the number and size of the electrical lines needed to power the electrical box, and comprises a pair of substantially parallel blades positioned on either side of each of the openings. The blades make an incision on an outer sheathing of the electrical cables when the electrical cables are inserted through the openings. The incision exposes the conductors and a deflector redirects the halves of sheathing into a dead zone (where there is no electrical communication) or completely out of the electrical box insert device. The exposed conductors can then be secured to the conductive bus bar continuatively connecting cables and/or terminating power to the electrical box. Furthermore, an electrical outlet can be secured via a sheathed electrical cable to the at least one conductive bus bar continuatively connecting cables.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the electrical box insert device without the top housing in place and an existing electrical box in accordance with the disclosed architecture.

FIG. 2 illustrates a perspective view of the electrical box insert device without the top housing in place and inserted into an existing electrical box in accordance with the disclosed architecture.

FIG. 3 illustrates a perspective view of electrical cables inserted through the electrical box insert device in accordance with the disclosed architecture.

FIG. 4 illustrates a front view of the electrical box insert device with the top housing secured and inserted into an existing electrical box in accordance with the disclosed architecture.

FIG. 5 illustrates a perspective view of an electrical outlet being connected to the electrical box insert device in accordance with the disclosed architecture.

FIGS. 6A-C illustrate a schematic view of each of the possible switch and receptacle scenarios for the electrical box insert device in accordance with the disclosed architecture.

FIG. 7 illustrates a perspective view of the electrical box insert device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention provides users with an easy way to install/remove electrical outlets/switches in a electrical box. The electrical box insert device allows electricians to work much more efficiently when installing and roughing in an electrical box or pot light. The disclosed device combines several steps to save an electrician time and energy. Further, the electrical box insert device does not leave wires vulnerable to being snipped or damaged by workers performing work in the house or building. Anyone who regularly installs and/or roughs in an electrical box or pot light may appreciate the convenience afforded by this device.

The disclosed electrical box insert device comprises a housing sized to be inserted into an existing electrical box. A sheathed electrical cable is inserted through an opening of the housing and secured to a conductive bus bar continuatively connecting cables and/or terminating power to an electrical box. The opening is sized to accommodate the number and size of the electrical lines needed to power the electrical box, and comprises a pair of substantially parallel blades positioned on either side of the opening. The blades make an incision on an outer sheathing of the electrical cable, exposing the conductors. The exposed conductors can then be secured to the conductive bus bar continuatively connecting cables. Furthermore, an electrical outlet can be secured via a sheathed electrical cable to the conductive bus bar continuatively connecting cables.

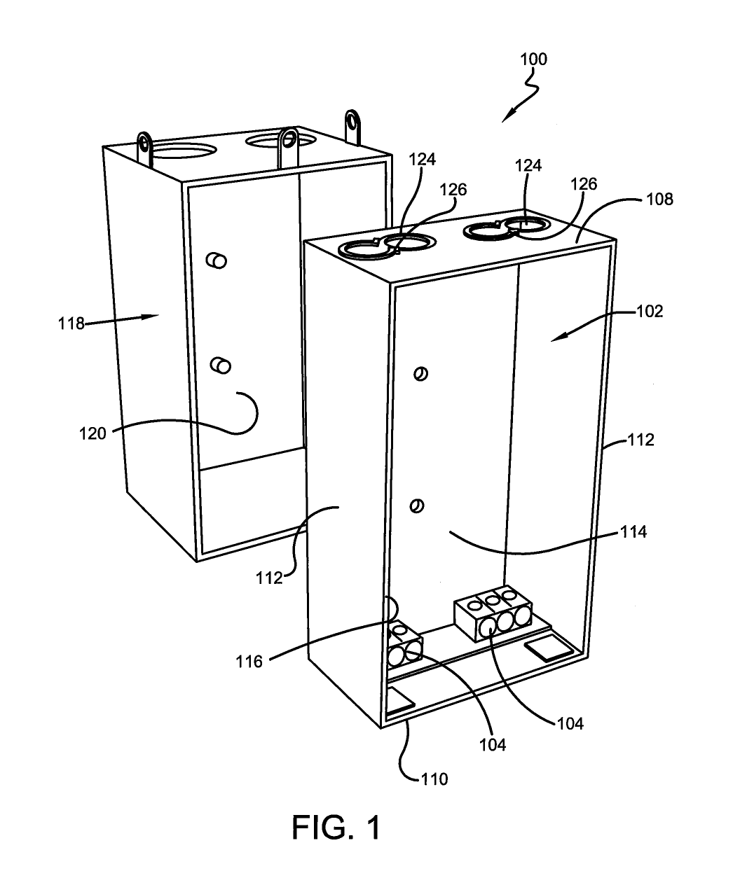

Referring initially to the drawings, FIGS. 1-5 illustrate the electrical box insert device 100 that provides users with an easy way to install/remove electrical outlets/switches in a electrical box. The electrical box insert device 100 comprises a housing 102, wherein at least one conductive bus bar 104 is secured to a bottom end 110 of the housing 102, and at least one opening 106 is positioned on the top end 108 of the housing 102 (as shown in FIG. 1). Additionally, the electrical box insert device 100 can be utilized with a plug and switch device, or a pot light device.

The housing 102 comprises a top end 108, a bottom end 110, opposing sides 112, and a back surface 114. Typically, the housing 102 is rectangular in shape if used for electrical plug and switch devices or cylindrical in shape if used for pot light devices, however any other suitable shape can be used as is known in the art without affecting the overall concept of the invention. The housing 102 would generally be constructed of plastic, polyvinyl chloride (PVC), nylon, polycarbonate (PC), etc., though any other suitable electrical insulating material may be used to manufacture the housing 102 as is known in the art without affecting the overall concept of the invention. The housing 102 can also comprise a variety of colors and designs to suit user and manufacturing preference. Further, the housing 102 can be any size and shape, depending on manufacturing and user preference.

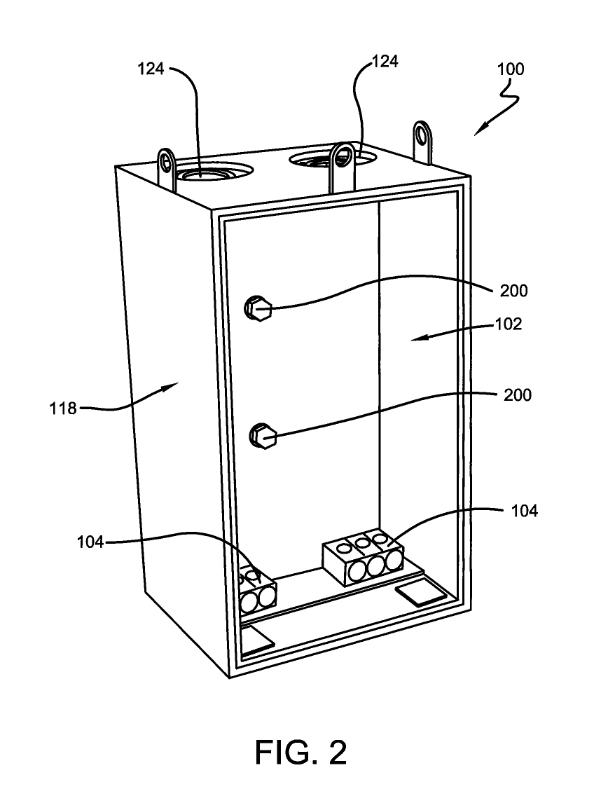

Typically, the housing 102 is sized to be inserted into an existing electrical box 118 or gang box (as shown in FIG. 2). The housing 102 is secured to the existing electrical box 118 via at least one of a fastener 200 (e.g., a bolt, etc.), or any other suitable securing means as is known in the art. However, the housing 102 can also be sized to replace a back plate 120 of an existing electrical box 118. Thus, the electrical box insert device 100 can be used to retrofit existing electrical boxes 118, and may also be incorporated within standard electrical boxes at the point of manufacture. Further, the housing 102 can be used with single, and double electrical boxes, or gang boxes.

The electrical box insert device 100 further comprises at least one conductive bus bar 104 secured to a bottom end 110 of the housing 102, however the at least one conductive bus bar 104 can be secured to any suitable position on the housing 102. The at least one conductive bus bar 104 (or terminal block) electrically connects the electrical cables 122 placing the electrical box insert device 100 in electrical communication with the existing electrical box 118. The at least one conductive bus bar 104 can be secured to the bottom end 110 of the housing 102 via any suitable securing means as is known in the art, such as gluing, welding, fasteners, etc. Further, any suitable number of conductive bus bars 104 can be used as is known in the art, and the conductive bus bars 104 can be positioned in any suitable configuration, depending on the users needs and/or wants. For example, the conductive bus bars 104 can be configured for one way, two way, three way or four way switching, or for dimmer switches, or even USB plus receptacles, etc.

The electrical box insert device 100 comprises at least one opening 124 positioned on the top end 108 of the housing 102, however the at least one opening 124 can be located at any suitable position on the housing 102. The opening 124 is sized to accommodate any number and size of electrical cables 122 or lines needed to power the electrical box. Furthermore in one embodiment, each of the openings 124 comprise a pair of substantially parallel blades 126 positioned on either side of each of the openings 124. The blades 126 make an incision on an outer sheathing of the electrical cables 122, and on the conductor sheathing, when the electrical cables 122 are inserted through the openings 124. The incisions expose the conductors and a deflector (not shown) redirects the halves of sheathing into a dead zone (where there is no electrical communication) or completely out of the electrical box insert device 100. The exposed conductors can then be secured to the conductive bus bar 104 continuatively connecting cables and/or terminating power to the electrical box 118.

In another embodiment, the blades 126 would only make an incision on the outer sheathing of the electrical cables 122, when the electrical cables 122 are inserted through the openings 124. Once inserted through the openings 124, the user would then manually strip the conductor sheathing, exposing the conductors. The exposed conductors can then be secured to the conductive bus bar 104 continuatively connecting cables and/or terminating power to the electrical box 118.

Furthermore, in another embodiment, the openings 124 do not comprises blades 126 and a user would manually strip the outer sheathing and the conductor sheathing via any suitable means, exposing the conductors. Once exposed, the conductors would be inserted through the openings 124 and then secured to the conductive bus bar 104 continuatively connecting cables and/or terminating power to the electrical box 118. Further, any suitable number of openings 124 and configurations of openings 124 can be used as is known in the art.

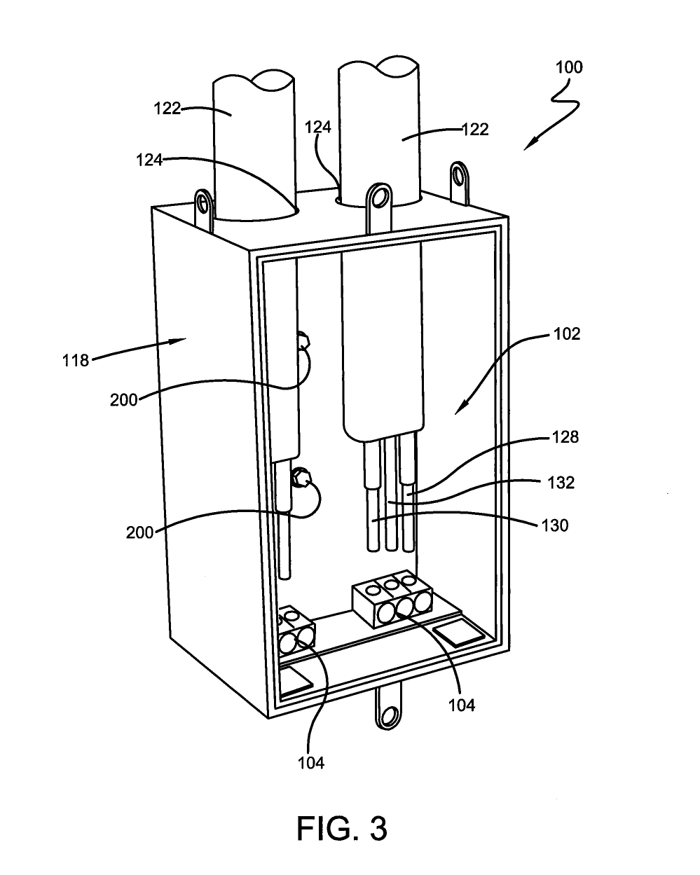

Further, at least one sheathed electrical cable 122 is inserted through the at least one opening 124 (as shown in FIG. 3) and secured to the at least one conductive bus bar 104 continuatively connecting cables 122 (i.e., placing the electrical cables 122 in electrical communication with the conductive bus bars 104), and/or terminating power to an electrical box 118. Specifically, the sheathed electrical cables 122 are stripped first (stripping the outer sheathing and even the conductor sheathing) and then inserted through the openings 124, or the sheathed electrical cables 122 are inserted through the openings 124, allowing the substantially parallel blades 126 to make an incision on an outer sheathing of the electrical cables 122 and conductor sheathing, exposing the conductors (i.e., the hot 128, the common 130, and the ground conductors 132). Furthermore, any suitable number of electrical cables 122 can be used as is known in the art, but typically there are two electrical cables 122, with one electrical cable 122 being inserted through each of the openings 124 of the housing 102.

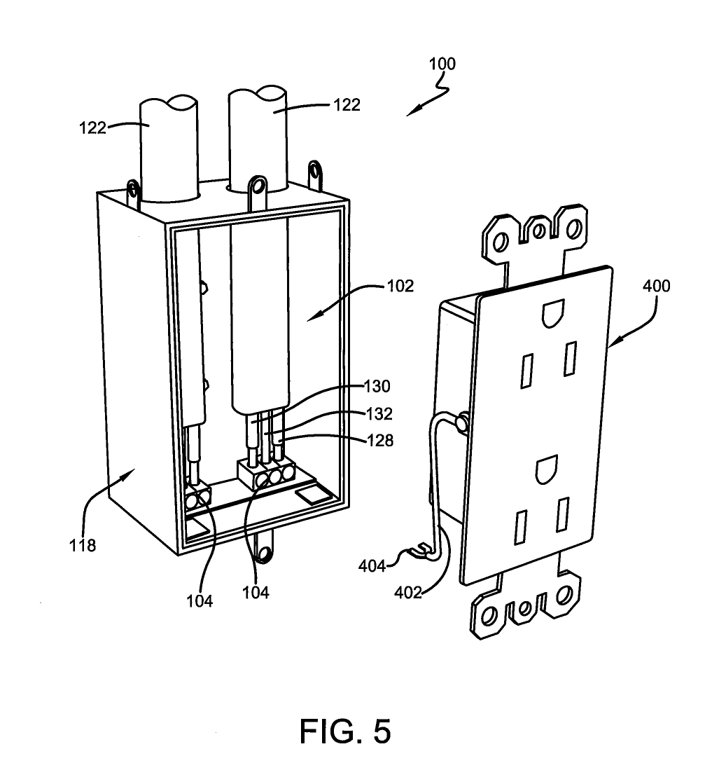

The electrical box insert device 100 further comprises an electrical outlet 400 secured via a sheathed electrical cable 402 to the at least one conductive bus bar 104 continuatively connecting cables. Typically the electrical outlet 400 can be secured to the conductive bus bar 104 via a prong connector 404, a fork connector, or any other suitable connector as is known in the art (as shown in FIG. 5). The device 100 may or may not use insulation displacement or insulation incisions through the outer cable 402 sheathing and conductor insulation. If so, then the device 100 will need the installer to manually remove the outer sheathing and conductor insulation then push in the cable 402 in color coordination, continuatively connecting all proper parallel connections. Or, the device 100 may or may not contain insulation displacement for just the outer cable 402 sheathing, but may use insulation displacement for only the conductor sheathing. If so, the installer will manually remove only the outer sheathing of the cable 402 and allow the device 100 when pushed in, to use insulation displacement or incision on the actual conductor sheathing.

Furthermore, every manufacturer, or production line of the device 100 can have there own configuration of any or all components disclosed herein. Additionally, the front portion of the device 100 will allow for the plug and play type receptacle devices or switch devices, including dimmers, to be a simple plug and play installation. The prongs will be manufactured on the back of all receptacles and switches, etc., to be easily received by the female end of the device 100 which is on the front (i.e., top housing 406) of the electrical box insert device 100.

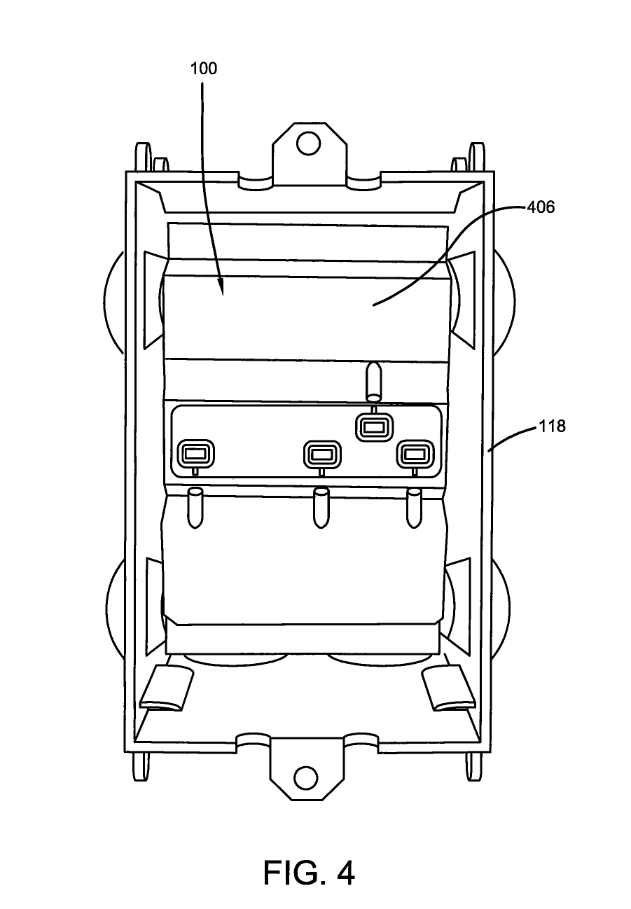

The electrical box insert device 100 can also comprise a top housing 406 (as shown in FIG. 4) to protect and secure the internal circuitry. The top housing 406 can be any suitable shape, size and design as is known in the art. A preferred embodiment of the top housing 406 design is shown in FIG. 4. However, each manufacturer would have their own electrical box insert device 100 configuration and design to insert. A different configuration could be used for one way, two way, three way, or four way switches, as well as dimmer switches, and/or USB plus receptacle configurations. Using the electrical box insert device 100 allows plugs and switches to act as receptacles, such that a user would only have pull out the plug or switch and push another one in its place, just like plugging in and unplugging a plug into a receptacle.

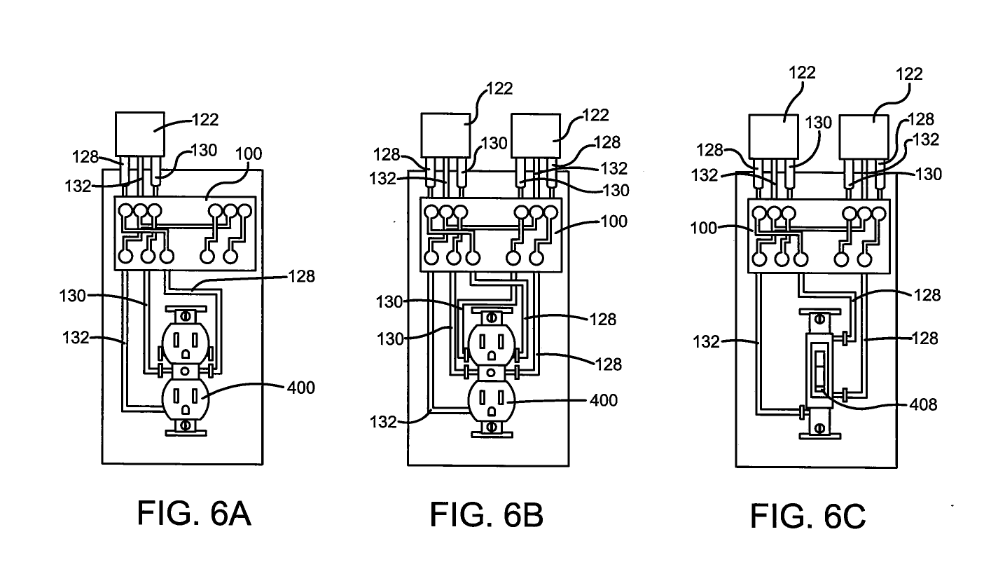

FIGS. 6A-C illustrate a schematic view of each of the possible switch and receptacle scenarios for the electrical box insert device 100. In FIG. 6A, the electrical cable 122 is at the end of the circuit and enters the electrical box insert device 100, with the conductors (i.e., the hot 128, the common 130, and the ground conductors 132) engaging the electrical outlet 400 to provide power. In FIG. 6B, the electrical cable 122 is in the middle of the circuit and enters the electrical box insert device 100, with the conductors (i.e., the hot 128, the common 130, and the ground conductors 132) engaging the electrical outlet 400 to provide power, and then the conductors (i.e., the hot 128, the common 130, and the ground conductors 132) exit the electrical box insert device 100 to provide power to another electrical outlet 400 in the circuit. In FIG. 6C, the electrical cable 122 enters the electrical box insert device 100, with the conductors (i.e., the hot 128 and the ground conductors 132) engaging the electrical switch 408 to provide power, and then exits the electrical box insert device 100 to provide power to the light fixture (not shown).

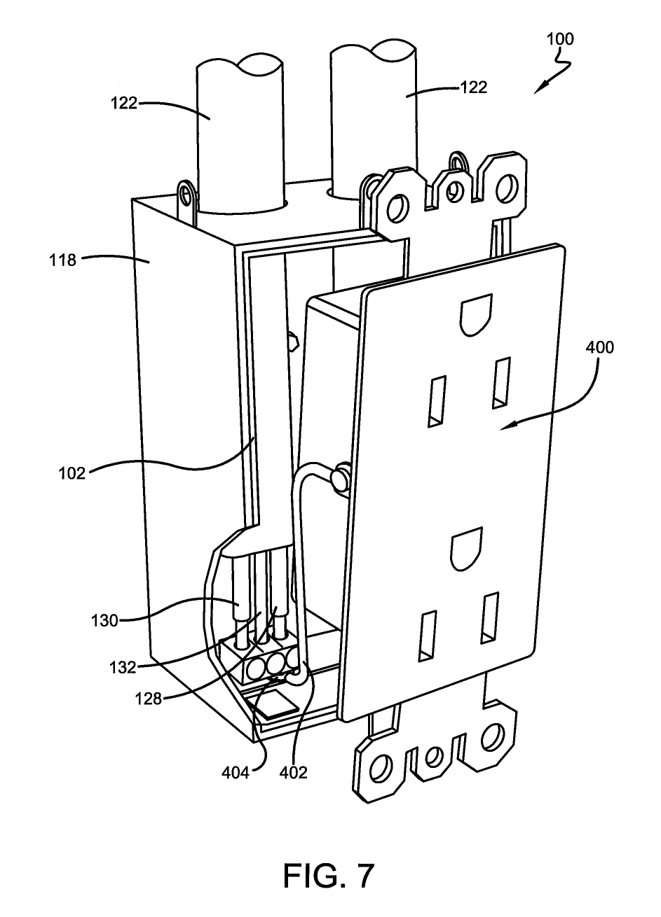

FIG. 7 illustrates the electrical box insert device 100 in use. In operation, a user (not shown) would choose the size and/or type of electrical box insert device 100 that meets their needs and/or wants, and that is sized to be inserted into an existing electrical box 118. The user would then position the electrical box insert device 100 into the existing electrical box 118 and would secure the device 100 in place via fasteners 200 or any other securing component as is known in the art.

Once secure, the user would insert a pair of sheathed electrical cables 122 through the pair of openings 124 at the top end 108 of the housing 102 of the electrical box insert device 100. Each opening 124 would be sized to accommodate the number and size of the electrical cables 122 or lines needed to power the electrical box. Further, each of the openings 124 would comprise a pair of substantially parallel blades 126 positioned on either side of each of the openings 124. As the user inserts a sheathed electrical cable 122 into each opening 124, the blades 126 make an incision on the outer sheathing of the electrical cables 122, exposing the conductors. A deflector redirects the halves of sheathing into a dead zone (where there is no electrical communication) or completely out of the electrical box insert device 100.

The user then secures the exposed conductors (i.e., the hot 128, the common 130, and the ground conductors 132) to the conductive bus bar 104 continuatively connecting cables and/or terminating power to the electrical box 118. The user then secures an electrical outlet 400 to the conductive bus bar 104 via a sheathed electrical cable 402 continuatively connecting cables. Typically the electrical outlet 400 is secured to the conductive bus bar 104 via a prong connector 404, or any other suitable connector as is known in the art. Once connected, the electrical outlet 400 is inserted into the electrical box insert device 100, and the electrical outlet 500 can be used as normal.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electrical box insert device comprising:
a housing comprising a top end, a bottom end, opposing sides, and a back surface;
at least one conductive bus bar secured to a bottom end of the housing;
at least one opening positioned on the top end of the housing; and
at least one electrical cable inserted in at least one opening and placed in electrical communication with the at least one conductive bus bar.

2. The electrical box insert device of claim 1, further comprising at least one of a group consisting of an electrical outlet, or an electrical switch placed in electrical communication with the at least one conductive bus bar.

3. The electrical box insert device of claim 1, wherein the at least one opening is sized to match a shape and a diameter of the at least one electrical cable.

4. The electrical box insert device of claim 3, wherein the at least one opening comprises a pair of parallel blades positioned on either side of the at least one opening to make an incision on an outer sheathing of the at least one electrical cable.

5. The electrical box insert device of claim 1, wherein the housing is sized to be inserted into an interior portion of an existing electrical box.

6. The electrical box insert device of claim 5, wherein the housing is secured to the existing electrical box via at least one of a fastener, or a bolt.

7. The electrical box insert device of claim 1, wherein the housing is sized to replace a back plate of an existing electrical box.

8. The electrical box insert device of claim 1, wherein the electrical box insert device is utilized with a plug and switch device.

9. The electrical box insert device of claim 1, wherein the electrical box insert device is utilized with a pot light device.

10. The electrical box insert device of claim 1, wherein the housing comprises a pair of openings positioned on the top end and a pair of conductive bus bars secured to the bottom end; and wherein a pair of electrical cables are inserted through the pair of openings and placed in electrical communication with the pair of conductive bus bars.

11. An electrical box insert device comprising:
a housing comprising a top end, a bottom end, opposing sides, and a back surface;
a pair of conductive bus bars secured to the bottom end of the housing;
a pair of openings positioned on the top end of the housing, and comprising a pair of parallel blades positioned on either side of each opening;
wherein a pair of electrical cables are inserted through the pair of openings and placed in electrical communication with the pair of conductive bus bars; and
wherein the pair of parallel blades make an incision on an outer sheathing of each electrical cable as the electrical cables are inserted into the openings.

12. The electrical box insert device of claim 11, further comprising an electrical outlet placed in electrical communication with one of the pair of conductive bus bars.

13. The electrical box insert device of claim 11, wherein the housing is sized to be inserted into an existing electrical box.

14. The electrical box insert device of claim 13, wherein the housing is secured to the existing electrical box via at least one of a fastener, or a bolt.

15. The electrical box insert device of claim 11, wherein the housing is sized to replace a back plate of an existing electrical box.

16. The electrical box insert device of claim 11, wherein the pair of openings are sized to match a shape and a diameter of the pair of electrical cables.

17. The electrical box insert device of claim 11, wherein the electrical box insert device is utilized with a plug and switch device.

18. The electrical box insert device of claim 11, wherein the electrical box insert device is utilized with a pot light device.

19. An electrical box insert device comprising:
a housing comprising a top end, a bottom end, opposing sides, and a back surface, and sized to be inserted into an existing electrical box; and
a pair of conductive bus bars secured to the bottom end of the housing;
a pair of openings positioned on the top end of the housing and sized to match a shape and a diameter of a pair of electrical cables;
wherein the pair of electrical cables are inserted through the pair of openings; and
wherein the pair of electrical cables are placed in electrical communication with the pair of conductive bus bars; and
wherein an electrical outlet is placed in electrical communication with the pair of conductive bus bars.

20. The electrical box insert device of claim 19, wherein the housing is secured to the existing electrical box via at least one of a fastener, or a bolt.
